(19) United States
(12) Patent Application Publication
(10) Pub. No.: US 2024/0032081 A1
(43) Pub. Date: Jan. 25, 2024

(54) ELECTRONIC DEVICE AND COMMUNICATION METHOD

(71) Applicants: Chen SUN, Beijing (CN); Sony Group Corporation, Tokyo (JP)

(72) Inventors: Chen SUN, Beijing (CN); Tao CUI, Beijing (CN)

(73) Assignee: Sony Group Corporation, Tokyo (JP)

(21) Appl. No.: 18/245,365

(22) PCT Filed: Oct. 15, 2021
(86) PCT No.: PCT/CN2021/123973

§ 371 Date: Mar. 15, 2023

(30) Foreign Application Priority Data
Oct. 21, 2020 (CN) 202011133344.1

(51) Int. Cl. H04W 72/53; H04W 72/04

(52) U.S. Cl. CPC H04W 72/53; H04W 72/04

(57) ABSTRACT

This disclosure relates to an electronic device and a communication method. An electronic device used at a terminal device side comprises a processing circuit configured to: provide, via a cellular link, a direct link resource usage demand and a cellular link resource usage demand of the terminal device to a base station, so that the base station allocates direct link resources and cellular link resources for the terminal device according to the direct link resource usage demand and the cellular link resource usage demand of the terminal device.

### CROSS-REFERENCING OF RELEVANT APPLICATIONS

This application requires the priority of a Chinese patent application No. 202011133344.1 filed on Oct. 21, 2020, the full text of which is incorporated herein by reference.

### TECHNICAL FIELD

The present disclosure relates to the field of communications, and more particularly, to allocation of cellular link resources and direct link resources.

### BACKGROUND

In a wireless communication system, a terminal device (hereinafter sometimes also referred to as user equipment, UE) can perform data interaction with a server through a base station, thereby implementing a mobile networking function. A communication link between the terminal device and the base station is referred to as a cellular link (hereinafter sometimes also referred to as uulink), which includes a cellular uplink and a cellular downlink. Furthermore, data exchange can be performed also using a direct link (referred to as sidelink or PC5 in the 3GPP standard) between terminal devices.

The sidelink has certain advantages over other direct connected networks (for example, Wi-Fi, Bluetooth). For example, the direct link of sidelink can ensure stable communication quality compared with such a network as Wi-Fi that does not ensure communication quality. In addition, compared with Bluetooth, the sidelink can provide communication with higher speed and longer distance. Therefore, the sidelink is a better choice in a scenario where direct communication that ensures communication quality and communication speed is needed.

### SUMMARY

A brief summary of the present disclosure is given below in order to provide a basic understanding of some aspects of the present disclosure. However, it should be understood that this summary is not an exhaustive summary of the present disclosure. It is not intended to determine key or important parts of the present disclosure, nor is it intended to limit the scope of the present disclosure. Its purpose is only to give some concepts of the present disclosure in a simplified form, as a prelude to a more detailed description to be given later.

Currently, the sidelink uses uplink resources. That is, the sidelink can only communicate in uplink resources within a range of a cell served by a base station. In addition, an uplink of the uulink also uses uplink resources. Therefore, if the base station allocates a large number of uplink resources to UEs in the cell for uulink uplink communication, it cannot be ensured that there are sufficient resources between UE and UE to implement sidelink communication. In addition, for one base station, a total number of uplink resources and downlink resources is finite, and if the base station allocates a large number of downlink resources for the UEs in the cell to perform uulink downlink communication, the uplink resources may be insufficient, so that it cannot be ensured that there are sufficient resources between UE and UE to implement the sidelink communication.

In view of one or more of the above problems, the present disclosure provides a coordination mechanism for the sidelink resources and the uulink resources, capable of reasonably allocating the sidelink resources and the uulink resources for the UE according to usage demands of the UE for the sidelink resources and the uulink resources.

According to an aspect of the present disclosure, there is provided an electronic device used at a terminal device side. The electronic device can comprise a processing circuit, which can be configured to: provide, via a cellular link, a direct link resource usage demand and a cellular link resource usage demand of the terminal device to a base station, so that the base station allocates direct link resources and cellular link resources for the terminal device according to the direct link resource usage demand and the cellular link resource usage demand of the terminal device.

According to another aspect of the present disclosure, there is provided an electronic device used at a base station side. The electronic device can comprise a processing circuit, which can be configured to: acquire, via a cellular link, a direct link resource usage demand and a cellular link resource usage demand of a terminal device. The processing circuit can be further configured to allocate direct link resources and cellular link resources for the terminal device according to the direct link resource usage demand and the cellular link resource usage demand.

According to another aspect of the present disclosure, there is provided a communication method. The method can comprise: a terminal device providing, via a cellular link, a direct link resource usage demand and a cellular link resource usage demand of the terminal device to a base station, so that the base station allocates direct link resources and cellular link resources for the terminal device according to the direct link resource usage demand and the cellular link resource usage demand of the terminal device.

According to another aspect of the present disclosure, there is provided a communication method. The method can comprise: a base station acquiring, via a cellular link, a direct link resource usage demand and a cellular link resource usage demand of a terminal device. The communication method can further comprise: the base station allocating direct link resources and cellular link resources for the terminal device according to the direct link resource usage demand and the cellular link resource usage demand.

According to another aspect of the present disclosure, there is provided a computer-readable storage medium comprising executable instructions which, when executed by an information processing apparatus, cause the information processing apparatus to perform the communication method according to the present disclosure.

According to one or more embodiments of the present disclosure, the usage demands of the UE for the sidelink resources and the uulink resources are comprehensively considered, so that the sidelink resources and the uulink resources can be reasonably allocated for the UEs.

### BRIEF DESCRIPTION OF THE DRAWINGS

The accompanying drawings, which constitute a part of this specification, illustrate embodiments of the present disclosure and together with the description, serve to explain the principles of the present disclosure.

The present disclosure can be more clearly understood according to the following detailed description and with reference to the accompanying drawings, in which:

FIG. 1 is a schematic diagram illustrating uulink and sidelink communications in a wireless communication system;

FIG. 2 is an exemplary configuration block diagram illustrating an electronic device used at a terminal device side according to an embodiment of the present disclosure;

FIG. 3 is an exemplary flow diagram illustrating a communication method used at a terminal device side according to an embodiment of the present disclosure;

FIG. 4 is an exemplary configuration block diagram illustrating an electronic device used at a base station side according to an embodiment of the present disclosure;

FIG. 5 is an exemplary flow diagram illustrating a communication method used at a base station side according to an embodiment of the present disclosure;

FIG. 6 illustrates an exemplary signaling diagram of interaction between a direct communication device group and a base station according to an embodiment of the present disclosure;

FIG. 7 is a block diagram illustrating a first example of a schematic configuration of a gNB according to an embodiment of the present disclosure;

FIG. 8 is a block diagram illustrating a second example of a schematic configuration of a gNB according to an embodiment of the present disclosure;

FIG. 9 is a block diagram illustrating an example of a schematic configuration of a smartphone according to an embodiment of the present disclosure; and

FIG. 10 is a block diagram illustrating an example of a schematic configuration of a car navigation device according to an embodiment of the present disclosure.

### DETAILED DESCRIPTION

Various exemplary embodiments of the present disclosure will now be described in detail with reference to the accompanying drawings. It should be noted that: the relative arrangement, numerical expressions, and numerical values of components and steps set forth in these embodiments do not limit the scope of the present disclosure unless specifically stated otherwise.

Meanwhile, it should be understood that a size of each portion shown in the drawings is not drawn to an actual scale for the convenience of description.

The following description of at least one exemplary embodiment is merely illustrative in nature and is in no way intended to limit this disclosure and its application or use.

Techniques, methods, and devices known to one of ordinary skill in the related art may not be discussed in detail but should be considered as a part of the specification where appropriate.

In all examples shown and discussed herein, any specific value should be construed as exemplary only and not as limiting. Thus, another example of the exemplary embodiment can have a different value.

It should be noted that: similar reference numbers and letters refer to similar items in the following drawings, and thus, once a certain item is defined in one drawing, it does not need to be discussed further in subsequent drawings.

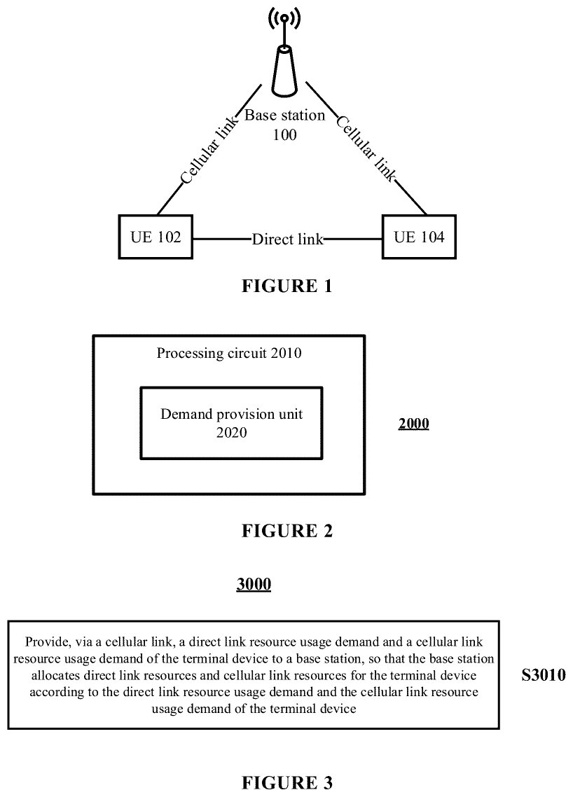

FIG. 1 illustrates a schematic diagram of uulink and sidelink communications in wireless communications.

Suppose a scenario where a UE 102 and a UE 104 perform an interactive game through a cloud game platform. Game data are stored on a cloud game server (not shown), and the UE 102 and the UE 104 respectively communicate with a base station 100 through a cellular link (uulink), so as to perform data interaction with the cloud game server via the base station 100. For example, the UE 102 and the UE 104 send game manipulation data to the cloud game server via the base station 100 through a uulink uplink, respectively. Then, the cloud game server sends game content updated after being manipulated by the UE 102 and the UE 104 to the UE 102 and the UE 104 through a uulink downlink, respectively. Furthermore, game interaction information (for example, user movement information) is interacted between the UE 102 and the UE 104 through a direct link (sidelink).

FIG. 1 exemplifies a case where the UE 102 and the UE 104 are controlled by the same base station 100. It should be appreciated that the UE 102 and the UE 104 can also be controlled by different base stations respectively, and communicate, via a cellular link, with the different base stations respectively.

Currently, the sidelink uses uplink resources. That is, the sidelink between the UE 102 and the UE 104 can only communicate in uplink resources within a range of a cell served by the base station 100. In addition, the uulink between the UE 102/104 and the base station 100 uses also uplink resources. Therefore, if the base station allocates a large number of uplink resources for the UEs in the cell to perform uulink uplink communication (for example, the UE 102/104 participating in the game needs to upload a large amount of game data to the game server, or an uplink communication demand of other UEs in the cell is great), it cannot be ensured that there are sufficient resources between UE and UE to implement the sidelink communication. Furthermore, for the base station 100, a total number of uplink and downlink resources is finite, and if the base station 100 allocates a large number of downlink resources for the UE 102/104 for uulink downlink communication (for example, the UE 102/104 participating in the game needs to download a large amount of game update data from the cloud game server), the uplink resources may be insufficient, which also cannot ensure that there are sufficient resources between UE and UE to implement the sidelink communication.

Therefore, a coordination mechanism between the sidelink resources and the uulink resources is needed, to comprehensively consider usage demands of the UE for the sidelink resources and the uulink resources, so that the sidelink resources and the uulink resources are reasonably allocated for the UEs.

A coordination allocation solution for the sidelink resources and the uulink resources according to the present disclosure will be described below with reference to FIGS. 2 to 6.

FIG. 2 illustrates an exemplary configuration block diagram of an electronic device 2000 used at a terminal device side according to an embodiment of the present disclosure. The electronic device 2000 can be used, for example, for the UE 102 or the UE 104 shown in FIG. 1.

In some embodiments, the electronic device 2000 can comprise a processing circuit 2010. The processing circuit 2010 of the electronic device 2000 provides various functions of the electronic device 2000. In some embodiments, the processing circuit 2010 of the electronic device 2000 can be configured to perform a communication method of the electronic device 2000 used at a terminal device side.

The processing circuit 2010 can refer to various implementations of digital circuitry, analog circuitry, or mixed signal (a combination of analog and digital) circuitry that performs the functions in a computing system. The processing circuit can comprise, for example, a circuit such as an integrated circuit (IC), an application specific integrated circuit (ASIC), a portion or circuit of an individual processor core, an entire processor core, an individual processor, a programmable hardware device such as a field programmable gate array (FPGA), and/or a system including multiple processors.

In some embodiments, the processing circuit 2010 can comprise a demand provision unit 2020 configured to perform a step S3010 in a communication method 3000 of the electronic device 2000 used at a terminal device side that is shown in FIG. 3 described later.

In some embodiments, the electronic device 2000 can also comprise a memory (not shown). The memory of the electronic device 2000 can store information generated by the processing circuit 2010, as well as program and data for operations of the electronic device 2010. The memory can be a volatile memory and/or non-volatile memory. For example, the memory can include, but is not limited to, a random access memory (RAM), dynamic random access memory (DRAM), static random access memory (SRAM), read-only memory (ROM), and flash memory.

In addition, the electronic device 2000 can be implemented at a chip level, or at a device level by comprising other external components. In some embodiments, the electronic device 2000 can be, as a whole machine, implemented as a terminal device, and can also comprise one or more antennas.

FIG. 3 illustrates an exemplary flow diagram of a communication method 3000 used at a terminal device side according to an embodiment of the present disclosure. The communication method can be used, for example, for the electronic device 2000 as shown in FIG. 2.

As shown in FIG. 3, in the step S3010, the demand provision unit 2020 of the terminal device provides, via a cellular link, a direct link resource usage demand and a cellular link resource usage demand of the terminal device to a base station, so that the base station allocates direct link resources and cellular link resources for the terminal device according to the direct link resource usage demand and the cellular link resource usage demand of the terminal device.

According to the present disclosure, on the basis that the direct link resource usage demand and the cellular link resource usage demand of the UE are comprehensively considered, the direct link resources and the cellular link resources are allocated for the UE, so that more reasonable resource allocation can be performed for the UE.

In some embodiments, the direct link resource usage demand of the UE can be indicated by at least one of channel busy ratio (CBR) or buffer status report (BSR) related to the direct link. The CBR can indicate a busy status of a current channel, and the BSR can indicate an amount of buffer data that the UE needs to upload currently. The two indicators can both be used for indicating the direct link resource usage demand of the UE. For example, the UE 102 can report its own CBR and/or BSR related to the sidelink to the base station 100, for the resource allocation by the base station 100.

In some embodiments, the cellular link resource usage demand of the UE is indicated by the buffer status report (BSR) related to the cellular link. For example, the UE 102 can report its own BSR related to the uulink to the base station 100, for the resource allocation by the base station 100.

It should be appreciated that information indicating the direct link resource usage demand and the cellular link resource usage demand of the UE is not limited to the BSR and CBR described above, and any other information capable of indicating the direct link resource usage demand and the cellular link resource usage demand can also be used. For example, the UE can report, to the base station, information of transmission failure or a case of no available resources in need of transmission, for indicating a corresponding resource usage demand.

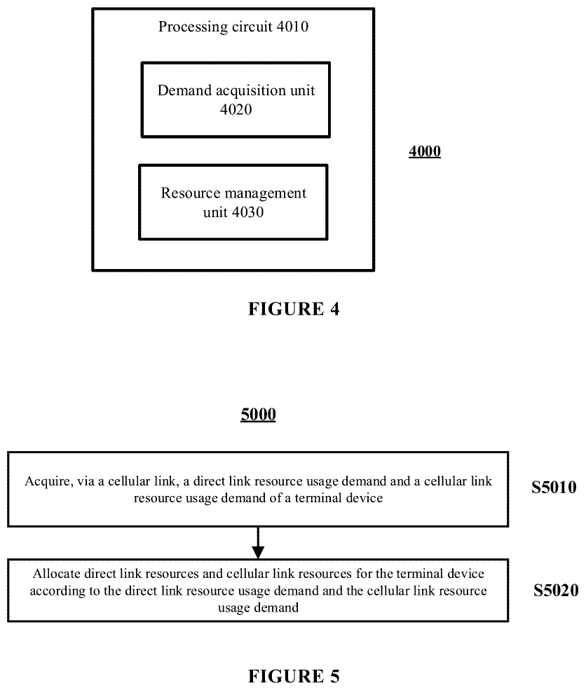

FIG. 4 illustrates an exemplary configuration block diagram of an electronic device 4000 used at a base station side according to an embodiment of the present disclosure. The electronic device 4000 can be used, for example, for the base station 100 shown in FIG. 1.

In some embodiments, the electronic device 4000 can comprise a processing circuit 4010. The processing circuit 4010 of the electronic device 4000 provides various functions of the electronic device 4000. In some embodiments, the processing circuit 4010 of the electronic device 4000 can be configured to perform a communication method of the electronic device 4000 for a base station.

The processing circuit 4010 can refer to various implementations of digital circuitry, analog circuitry, or mixed signal (a combination of analog and digital) circuitry that performs the functions in a computing system. The processing circuit can comprise, for example, a circuit such as an integrated circuit (IC), an application specific integrated circuit (ASIC), a portion or circuit of an individual processor core, an entire processor core, an individual processor, a programmable hardware device such as a field programmable gate array (FPGA), and/or a system including multiple processors.

In some embodiments, the processing circuit 4010 can comprise a demand acquisition unit 4020 and a resource management unit 4030 respectively configured to perform steps S5010 and S5020 in a communication method 5000 of the electronic device 4000 used at a base station side shown in FIG. 5 described later.

In some embodiments, the electronic device 4000 can also comprise a memory (not shown). The memory of the electronic device 4000 can store information generated by the processing circuit 4010 and program and data for operations of the electronic device 4010. The memory can be a volatile memory and/or non-volatile memory. For example, the memory can include, but is not limited to, a random access memory (RAM), dynamic random access memory (DRAM), static random access memory (SRAM), read-only memory (ROM), and flash memory.

In addition, the electronic device 4000 can be implemented at a chip level, or at a device level by comprising other external components. In some embodiments, the electronic device 4000 can be, as a whole machine, implemented as a terminal device, and can also comprise one or more antennas.

It should be understood that the above units are merely logic modules divided according to the specific functions they implement, and are not used for limiting the specific implementations. In actual implementations, the above units can be implemented as independent physical entities, or can be implemented by a single entity (for example, a processor (CPU or DSP, etc.), an integrated circuit, etc.).

FIG. 5 illustrates an exemplary flow diagram of a communication method 5000 used at a base station side according to an embodiment of the present disclosure. The communication method can be used, for example, for the electronic device 4000 as shown in FIG. 4.

As shown in FIG. 5, in the step S5010, the demand acquisition unit 4020 of the base station acquires, via a cellular link, a direct link resource usage demand and a cellular link resource usage demand of a terminal device. In the step S5020, the resource management unit 4030 of the base station allocates direct link resources and cellular link resources for the terminal device according to the direct link resource usage demand and the cellular link resource usage demand.

In some embodiments, the resource management unit 4030 can be implemented by a scheduler of a 3GPP protocol stack MAC. In other embodiments, the resource management unit 4030 can be implemented at a RRC layer, and is, at the RRC layer, responsible for the RRC to manage a SPS period and manage configurations of uplink and downlink resources through the RRC. In still other embodiments, the resource management unit 4030 can also be an apparatus existing in an application media control unit, which reasonably configures the uplink and downlink resources through the RRC or the scheduler of the MAC according to an actual application data request.

According to the present disclosure, on the basis that the direct link resource usage demand and the cellular link resource usage demand of the UE are comprehensively considered, the direct link resources and the cellular link resources are allocated for the UE, so that more reasonable resource allocation can be made for the UE.

In some embodiments, the resource management unit 4030 of the base station can adjust a proportion of the direct link resources in the uplink resources according to the direct link resource usage demand and the cellular link resource usage demand of the UE, and allocate the direct link resources and the cellular link resources for the UE according to the adjusted proportion.

For example, in the scenario where the UE 102 and the UE 104 perform the interactive game through the cloud game platform, as shown in FIG. 1, when there is more interaction between the UE 102 and the UE 104, more sidelink resources are needed. At this time, if the UE 102 transmits fewer game manipulation data to the game server via the base station 100, fewer uulink uplink resources are used. In this case, as can be learned from the sidelink resource usage demand (for example, indicated by the BSR/CBR of the sidelink) and the uulink resource usage demand (for example, indicated by the BSR of the uulink) provided by the UE 102 to the base station 100, the UE 102 needs more sidelink resources and fewer uulink uplink resources. Therefore, the resource management unit 4030 of the base station 100 can increase the proportion of the sidelink resources in the uplink resources, thereby allocating more sidelink resources to the UE 102. Accordingly, the uulink uplink resources in the uplink resources are reduced, thereby allocating fewer uulink resources for the UE 102. Therefore, the sidelink and uulink resources can be reasonably allocated for the UE according to the demands of the UE.

In some embodiments, the resource management unit 4030 of the base station can adjust a ratio of the uplink resources to the downlink resources according to the direct link resource usage demand and the cellular link resource usage demand of the UE, and allocate the direct link resources and the cellular link resources for the UE according to the adjusted ratio.

Still taking as an example the scenario where the UE 102 and the UE 104 perform the interactive game through the cloud game platform as shown in FIG. 1, when there are more interaction between the UE 102 and the UE 104, more sidelink resources are needed. At this time, if the UE 102 also sends more game manipulation data to the game server via the base station 100, more uulink uplink resources are also needed. In this case, as can be learned from the sidelink resource usage demand (for example, indicated by the BSR/CBR of the sidelink) and the uulink resource usage demand (for example, indicated by the BSR of the uulink) provided by the UE 102 to the base station 100, the UE 102 needs more sidelink resources and also needs more uulink uplink resources. Therefore, the resource management unit 4030 of the base station 100 can increase the ratio of the uplink resources to the downlink resources, thereby increasing the total number of the uplink resources, so that more sidelink resources and uulink resources can be allocated for the UE 102. Therefore, the sidelink and uulink resources can be reasonably allocated for the UE according to the demands of the UE.

In the above embodiments, the case where each UE (for example, the UE 102 and the UE 104) provides the sidelink and uulink resource usage demands to the base station (for example, the base station 100) respectively is described. In this case, the base station allocates the sidelink resources for each UE, respectively.

In some embodiments, a plurality of UEs that communicate with each other via a direct link can form a direct communication device group, and a leading UE in the direct communication device group can acquire sidelink and uulink resource usage demands of other UEs, and report the demands to the base station uniformly. The base station allocates a sidelink resource pool for the direct communication device group according to sidelink and uulink resource usage demands of the direct communication device group. Each UE in the direct communication device group autonomously selects resources in the resource pool for sidelink communication.

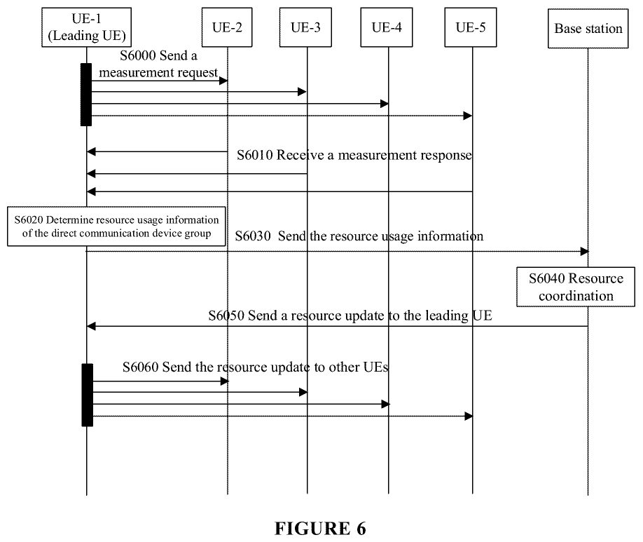

Hereinafter, a solution for communication and resource allocation between the direct communication device group and the base station will be described below specifically with reference to FIG. 6.

FIG. 6 illustrates an exemplary signaling diagram of interaction between a direct communication device group and a base station according to an embodiment of the present disclosure. UE-1 to UE-5 communicate with each other via a direct link and form a direct communication device group, wherein the UE-1 is a leading UE that communicates with the base station via a cellular link.

The UE-1, as the leading UE, can acquire, via a direct link, direct link resource usage demands and cellular link resource usage demands of other UEs. This step can be realized, for example, by steps S6000 and S6010 shown in FIG. 6.

Specifically, in the step S6000, the UE-1 respectively sends, to the other UEs (i.e., the UE-2 to the UE-5), a measurement request, for measuring resource usage demands of uulinks and sidelinks of the other UEs. As described above, the resource usage demand of the uulink can be indicated, for example, by the BSR related to the uulink, and the resource usage demand of the sidelink can be indicated, for example, by the BSR and/or CBR related to the sidelink.

Next, in the step S6010, the UE-1 respectively receives a measurement response from the UE-2 to the UE-5, to obtain the resource usage demands of the uulinks and the sidelinks of the UE-2 to the UE-5.

In step S6020, the UE-1 determines resource usage information of the direct communication device group according to its own resource usage demand and the resource usage demands obtained from the other UEs. The resource usage information can comprise, for example, uulink and sidelink resource usage demands of the direct communication device group.

In some embodiments, the UE-1 can determine a maximum sidelink resource usage demand in the UEs in the direct communication device group as the sidelink resource usage demand of the direct communication device group. For example, in the case of using the BSR to indicate the sidelink resource usage demand, the UE-1 can select, from respective sidelink BSRs of the UEs (i.e., UE-1 to UE-5), a maximum BSR, for indicating a maximum sidelink resource usage demand and reporting it to the base station as the sidelink resource usage demand of the direct communication device group. In addition, similar processing can be performed for the case of using the CBR to indicate the sidelink resource usage demand.

In other embodiments, the UE-1 can also determine an average sidelink resource usage demand of the UEs in the direct communication device group as a sidelink resource usage demand of the direct communication device group. For example, in the case of using the BSR to indicate the sidelink resource usage demand, the UE-1 can average sidelink BSRs of the UEs (i.e., UE-1 to UE-5), and the average sidelink BSR is used to indicate the sidelink resource usage demand of the direct communication device group, and reported to the base station. In addition, similar processing can be performed for the case of using the CBR to indicate the sidelink resource usage demand.

In some embodiments, the UE-1 can determine a sum of the uulink resource usage demands of the UEs (i.e., the UE-1 to the UE-5) in the direct communication device group as a uulink resource usage demand of the direct communication device group. For example, in the case of using the BSR to indicate the uulink resource usage demand, the UE-1 can sum the amount of buffer data that is indicated by uulink BSRs of the UEs (i.e., UE-1 to UE-5), and the sum is reported to the base station as the uulink BSR of the direct communication device group.

In some embodiments, the UE-1 can collect other information capable of representing the uulink and sidelink resource usage situations, for determining the uulink and sidelink resource usage demands of the direct communication device group. For example, the UE-1 can collect information about transmission failures of the UEs or a case of no available resources in need of transmission by the UE, and analyze the information collected from the UEs to determine the uulink and sidelink resource usage demands of the direct communication device group. In addition, the information can be considered together with the sidelink BSRs/CBRs and the uulink BSRs of the UEs, thereby determining the uulink and sidelink resource usage demands of the direct communication device group.

Next, in step S6030, the UE-1 sends, via a cellular link, the resource usage information to the base station, thereby providing the uulink and sidelink resource usage demands of the direct communication device group to the base station.

Furthermore, in the steps S6020 and S6030, the case where the UE-1, as the leading UE, determines the resource usage demands of the direct communication device group and reporting them to the base station is described. However, in some embodiments, this determination process can also be implemented at the base station. For example, the UE-1 collects the uulink and sidelink resource usage demands of the UEs and directly reports them to the base station, and the base station determines uulink and sidelink resource usage demands of the direct communication device group according to these resource usage demands.

Next, in step S6040, the base station performs resource coordination according to the received resource usage information.

In some embodiments, the base station can allocate a direct link resource pool for the direct communication device group according to the uulink and sidelink resource usage demands of the direct communication device group. Specifically, the base station can, according to the above resource usage demands, judge whether uplink resource timeslots are allocated too few or available resources of the sidelink resource pool are insufficient, so as to perform reasonable resource allocation according to different specific situations.

When the sidelink resource usage demand of the direct communication device group is great, the available resources of the sidelink resource pool may be insufficient. In this case, the base station can dynamically adjust a size of the direct link resource pool, thereby allocating a larger direct link resource pool for the direct communication device group. At this time, resources for the uulink uplink will be reduced accordingly.

When the sidelink resource usage demand and the uulink uplink resource usage demand of the direct communication device group are both great, since both sidelink resources and uulink uplink resources use uplink resources, current uplink resources may not meet the sidelink and uulink resource usage demands of the direct communication device group. In this case, the base station can adjust a ratio of the uplink resources to downlink resources so that a proportion of the uplink resources is increased. After the ratio is adjusted, available uplink resources become more, so that the usage demands of the sidelink resources and the uulink uplink resources can be met.

In some embodiments, the base station can allocate cellular downlink multicast resources to the direct communication device group according to the direct link resource usage demand and cellular link resource usage demand of the direct communication device group.

For example, in the scenario where the UEs-1 to UE-5 perform game interaction, the UE-2 uploads game interaction data to the cloud game server through a uulink uplink, the uploading of the game interaction data will result in an update of game content, and the update of the game content needs to be sent to all the UE-1 to UE-5 through a uulink downlink, to ensure that the UEs all obtain the update of the game data in time. That is, even if uplink data of only one UE is uploaded, it may cause all the UEs in the direct communication device group to generate a downlink resource usage demand. For this case, in some embodiments, the base station can uniformly allocate the uulink downlink multicast resources for the direct communication device group according to the uulink and sidelink resource usage demands of the direct communication device group. The UEs in the direct communication device group download the game data, for example, by using the multicast resources, so that it can be ensured that the UEs all obtain the data update in time.

In some embodiments, a uulink downlink multicast resource demand of the direct communication device group can also be estimated by the cloud game server according to game interaction data uploaded by the direct communication device group, and notified to the base station. The base station allocates the uulink downlink multicast resources for the direct communication device group according to the uulink downlink multicast resource demand.

Next, in step S6050, the base station sends a resource update to the UE-1 as the leading UE. For example, the base station can send, to the UE-1, the sidelink resource pool and/or the uulink downlink multicast resources allocated for the direct communication device.

In step S6060, the UE-1 sends the resource update to the other UEs, respectively. For example, the UE-1 can send the sidelink resource pool and/or uulink downlink multicast resources to the other UEs, respectively. Therefore, the UEs can perform corresponding sidelink communication and uulink communication in the updated sidelink resource pool and/or uulink downlink multicast resources.

Furthermore, in step S6050, the base station can also directly send the resource update to the UEs, respectively. In this case, there is no need for the UE-1 as the leading UE to send the resource update to the other UEs in the step S6060.

The solution for the communication and resource allocation between the direct communication device group and the base station is described above in combination with FIG. 6. In this solution, only the leading UE communicates with the base station via the uulink, without each UE communicating with the base station separately. Therefore, only the leading UE is required to keep a link state with the base station, and the other UEs can be in an unlinked state, so that complexity of the resource allocation performed by the base station can be reduced, and system overhead can be reduced. In this way, especially in the case where the number of UEs in the direct communication device group is great, the complexity of the resource allocation and the system overhead can be reduced more significantly.

In some embodiments, the leading UE in the direct communication device group can also acquire location information of the UEs, in addition to the uulink and sidelink resource usage demands of the UEs. This step can also be realized, for example, by the steps S6000 and S6010 shown in FIG. 6, where the measurement request in the step S6000 comprises a measurement request for location information of the other UEs, and the measurement in the step S6010 correspondingly comprises respective location information measured by the other UEs.

Next, in the step S6020, the UE-1 determines a maximum distance between the terminal devices in the direct communication device group according to the location information of the UEs. The maximum distance can be included in the resource usage information of the direct communication device group, and sent to the base station in the step S6030.

In the step S6040, the base station performs resource coordination according to the received maximum distance, and determines at least one of a spatial usage range of the direct link resource pool allocated for the direct communication device group or minimum direct communication transmission power of the direct communication device group.

In some embodiments, to ensure that the UEs in the direct communication device group can use the same sidelink resource pool, the spatial usage range of the direct link resource pool can be determined by using the maximum distance between the UEs. Therefore, the UEs are caused to be all located within the usage range, and therefore, it can be ensured that the UEs all can use the same sidelink resource pool.

In some embodiments, the minimum direct communication transmission power of the direct communication device group can also be determined by using the maximum distance between the UEs. For example, transmission power that can ensure transmission with the maximum distance can be determined as the minimum direct communication transmission power. Therefore, transmission power of the UEs in the direct communication device group can be saved in the case where quality of the transmission is ensured.

Next, similar to the above description, in the step S6050, the base station sends, to the UE-1, resource update (for example, the spatial usage range of the direct link resource pool and/or the minimum direct communication transmission power of the direct communication device group), and in the step S6060, the UE-1 sends the resource update to the other UEs.

In some cases, even if the proportion of the sidelink resources in the uplink is adjusted and the ratio of the uplink resources to the downlink resources is adjusted, the resource coordination between the uulink and sidelink cannot be achieved. For example, if there are a large number of UEs in the cell that need uulink downlink resources, or the UEs in the game need to download a large amount of data, uplink resources may be insufficient, thereby resulting in insufficient sidelink resources. In this case, an application layer media distribution mode of the UE can be adjusted by providing the application media control unit at the UE or the base station.

In some embodiments, the application media control unit can be provided at the UE, and adjust the application layer media distribution mode of the UE according to the sidelink and uulink resource usage demands of the UE. For example, in the case where a large number of uulink downlink resources are needed in a cell and sufficient sidelink resources cannot be ensured, the application layer media distribution mode of the UE can be adjusted, so that more interactions between the UEs are realized through the uulink, and more rendering are realized at the network side, thereby reducing the sidelink resource usage demand. Conversely, in the case where the uulink downlink resource demand in the cell is less and more sidelink resources can be ensured, the application layer media distribution mode of the UE can be adjusted, to cause more interactions between the UEs to be realized through the sidelink and more local rendering to be realized at the UE.

In some embodiments, the application media control unit can also be provided at the base station, and provide, to the UE, a media distribution control instruction for adjusting the application layer media distribution mode of the UE, according to the sidelink and uulink resource usage demands provided by the UE to the base station.

In addition, in the scenario where the plurality of UEs perform game interaction and interact game data with the game server, the application media control unit can also correspondingly adjust a media distribution mode of the game server to suit the uulink and sidelink resource usage demands.

According to the above embodiments, the content distribution of the application can be adjusted according to the network performance through an application layer, so that user experience is improved.

Next, interference between adjacent cells is considered.

If no coordination is performed on uplinks and downlinks of the adjacent cells, interference between the adjacent cells may be caused. Therefore, in some embodiments, the base station adjusts the allocation of the direct link resources and cellular link resources for the UE according to interference with an adjacent base station. Therefore, the interference between the adjacent cells can be reduced.

In some embodiments, the base station can interact UE location information with the adjacent base station. The UE location information can indicate, for example, a geographical location of a single UE served by the base station or a geographical location of the direct communication device group consisting of the plurality of UEs. The base station can determine, by interacting the UE location information with the adjacent base station, interference with the adjacent base station that occurs at a location indicated by the UE location information, and according to the interference, adjust the allocation of the direct link resources and the cellular link resources for the UE (for example, the proportion of the sidelink resources in the uplink resources, and the ratio of the uplink resources to the downlink resources), to reduce the interference between the adjacent cells.

In some embodiments, if the base station and the adjacent base station are both NR base stations, the base station can, through an Xn interface, perform information interaction and coordination with the adjacent base station. In some embodiments, if the base station and the adjacent base station are both LTE base stations, the base station can, through an X2 interface, perform information interaction and coordination with the adjacent base station. It should be understood that in the case where the base station is an NR base station and the adjacent base station is an LTE base station (or vice versa), the base station can also perform information interaction and coordination with the adjacent base station. In some embodiments, the base station can also spatially reduce the resource interference between the adjacent cells by controlling a beamforming direction (for a millimeter wave band).

According to the embodiment, the allocation of the direct link resources and the cellular link resources for the UE can be adjusted through the information interaction and coordination with the adjacent cell, so that the interference between the adjacent cells is reduced.

In the above description, by taking the scenario of the game interaction among the plurality of UEs as an example, the solution for coordination and allocation of the sidelink resources and the uulink resources according to the embodiment of the present disclosure is described. It should be appreciated that the technique according to the present disclosure can be similarly applied to other scenarios, such as the Internet of Vehicles, Internet of Things, etc., in which sidelink resources and uulink resources are used simultaneously.

Application examples according to the present disclosure will be described below.

The technique of the present disclosure can be applied to a variety of products.

For example, the base station can be implemented as any type of evolved node B (eNB) or gNodeB (gNB) in next generation radio access technology, such as macro eNB/gNB and small eNB/gNB. The small eNB/gNB can be an eNB/gNB covering a cell smaller than a macrocell, such as a pico eNB/gNB, a micro eNB/gNB, and a home (femto) eNB/gNB. Alternatively, the base station can be implemented as any other type of base station, such as one or both of a base transceiver (BTS) and a base station controller (BSC) in a GSM system, can be one or both of a radio network controller (RNC) and a NodeB in a WCDMA system, or can be a corresponding network node in a future communication system. The base station can comprise: a main body (also referred to as a base station device) configured to control wireless communication; and one or more remote radio heads (RRHs) provided at a different place from the main body. In addition, various types of terminals, which will be described below, can work as the base station by temporarily or semi-persistently performing the base station function.

For example, the terminal device can be implemented as a mobile terminal (such as a smart phone, a tablet personal computer (PC), a notebook PC, a portable game terminal, a portable/dongle-type mobile router, and a digital camera), or a vehicle-mounted terminal (such as a car navigation device). The terminal device can also be implemented as a terminal that performs machine-to-machine (M2M) communication (also referred to as a machine-type communication (MTC) terminal). Furthermore, the terminal device can be a wireless communication module (such as an integrated circuit module including a single chip) mounted on each of the above terminals.

[Application Example with Respect to Base Station]

### First Application Example

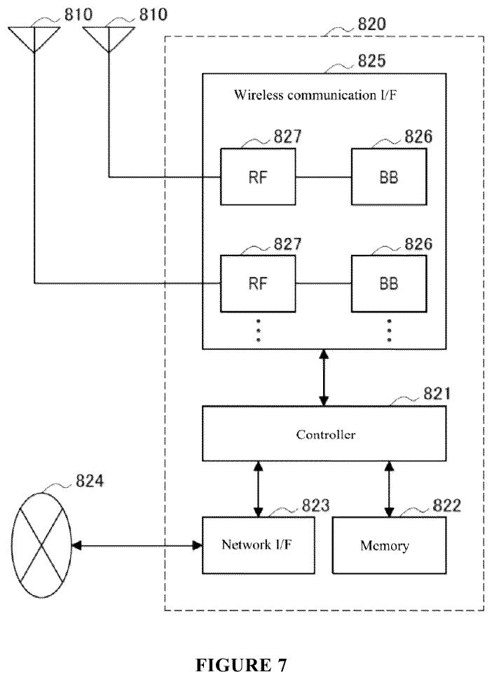

FIG. 7 is a block diagram illustrating a first example of a schematic configuration of a gNB to which the technique of the present disclosure can be applied. The gNB 800 comprises one or more antennas 810 and a base station device 820. The base station device 820 and each antenna 810 can be connected to each other via an RF cable.

Each of the antennas 810 comprises a single or a plurality of antenna elements (such as a plurality of antenna elements included in a multiple-input multiple-output (MIMO) antenna), and is used for the base station device 820 to send and receive a wireless signal. As shown in FIG. 7, the gNB 800 can comprise a plurality of antennas 810. For example, the plurality of antennas 810 can be compatible with a plurality of bands used by the gNB 800. The base station device 820 comprises a controller 821, a memory 822, a network interface 823 and a wireless communication interface 825.

The controller 821 can be, for example, a CPU or a DSP, and operates various functions of a higher layer of the base station device 820. For example, the controller 821 generates a data packet according to data in a signal processed by the wireless communication interface 825 and transfers the generated packet via the network interface 823. The controller 821 can bundle data from a plurality of baseband processors to generate a bundle packet and transfer the generated bundle packet. The controller 821 can have a logic function for performing the following control: such as radio resource control, radio bearer control, mobility management, admission control, and scheduling. This control can be performed in combination with a nearby gNB, eNB or core network node (such as access and mobility management function (AMF)). The memory 822 comprises an RAM and ROM, and stores a program executed by the controller 821 and various types of control data (such as a terminal list, transmission power data, and scheduling data).

The network interface 823 is a communication interface for connecting the base station device 820 to a core network 824. The controller 821 can, via the network interface 823, communicate with a core network node or another gNB/eNB. In this case, the gNB 800 and the core network node or other gNB/eNB can be connected to each other through a logical interface (such as an N2 interface and AMF, and an Xn interface and gNB). The network interface 823 can also be a wired communication interface, or a wireless communication interface for a wireless backhaul. If the network interface 823 is the wireless communication interface, the network interface 823 can use a higher band for wireless communication than a band used by the wireless communication interface 825.

The wireless communication interface 825 supports any cellular communication solution (such as LTE, LTE-advanced, NR (New Radio)), and provides a wireless connection to a terminal located in a cell of the gNB 800 via the antenna 810. The wireless communication interface 825 can generally comprise, for example, a baseband (BB) processor 826 and an RF circuit 827. The BB processor 826 can perform, for example, encoding/decoding, modulation/demodulation, and multiplexing/demultiplexing, and perform various types of signal processing of layers (such as L1, medium access control (MAC), radio link control (RLC), and packet data convergence protocol (PDCP)). In place of the controller 821, the BB processor 826 can have part or all of the above logic functions. The BB processor 826 can be a memory storing a communication control program, or a module comprising a processor configured to execute a program and related circuits. An update program can cause the function of the BB processor 826 to change. The module can be a card or blade that is inserted into a slot of the base station device 820. Alternatively, the module can be a chip mounted on the card or blade. Meanwhile, the RF circuit 827 can comprise, for example, a mixer, a filter, and an amplifier, and transmits and receives a wireless signal via the antenna 810.

As shown in FIG. 7, the wireless communication interface 825 can comprise a plurality of BB processors 826. For example, the plurality of BB processors 826 can be compatible with a plurality of bands used by the gNB 800. As shown in FIG. 7, the wireless communication interface 825 can comprise a plurality of RF circuits 827. For example, the plurality of RF circuits 827 can be compatible with the plurality of antenna elements. Although FIG. 7 shows an example in which the wireless communication interface 825 comprises the plurality of BB processors 826 and the plurality of RF circuits 827, the wireless communication interface 825 can also comprise a single BB processor 826 or a single RF circuit 827.

### Second Application Example

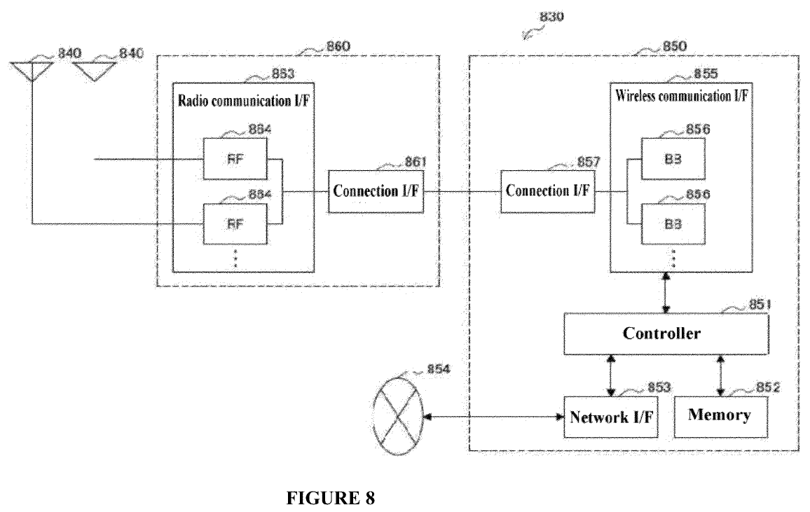

FIG. 8 is a block diagram illustrating a second example of a schematic configuration of a gNB to which the technique of the present disclosure can be applied. A gNB 830 comprises one or more antennas 840, a base station device 850, and an RRH 860. The RRH 860 and each antenna 840 can be connected to each other via an RF cable. The base station device 850 and RRH 860 can be connected to each other via a high-speed line such as an optical fiber cable.

Each of the antennas 840 comprises a single or a plurality of antenna elements (such as a plurality of antenna elements included in an MIMO antenna) and is used for the RRH 860 to send and receive a wireless signal. As shown in FIG. 8, the gNB 830 can comprise a plurality of antennas 840. For example, the plurality of antennas 840 can be compatible with a plurality of bands used by the gNB 830. The base station device 850 comprises a controller 851, a memory 852, a network interface 853, a wireless communication interface 855, and a connection interface 857. The controller 851, the memory 852, and the network interface 853 are the same as the controller 821, the memory 822, and the network interface 823 described with reference to FIG. 7.

The wireless communication interface 855 supports any cellular communication solution (such as LTE and LTE-advanced), and provides, via the RRH 860 and the antenna 840, wireless communication to a terminal located in a sector corresponding to the RRH 860. The wireless communication interface 855 can generally comprise, for example, a BB processor 856. Except that the BB processor 856 is connected to the RF circuit 864 of the RRH 860 via the connection interface 857, the BB processor 856 is the same as the BB processor 826 described with reference to FIG. 7. As shown in FIG. 8, the wireless communication interface 855 can comprise a plurality of BB processors 856. For example, the plurality of BB processors 856 can be compatible with a plurality of bands used by the gNB 830. Although FIG. 8 shows an example in which the wireless communication interface 855 comprises the plurality of BB processors 856, the wireless communication interface 855 can also comprise a single BB processor 856.

The connection interface 857 is an interface for connecting the base station device 850 (the wireless communication interface 855) to the RRH 860. The connection interface 857 can also be a communication module for communication in the above high-speed line that connects the base station device 850 (the wireless communication interface 855) to the RRH 860.

The RRH 860 comprises a connection interface 861 and a radio communication interface 863.

The connection interface 861 is an interface for connecting the RRH 860 (radio communication interface 863) to the base station device 850. The connection interface 861 can also be a communication module for communication in the above high-speed line.

The radio communication interface 863 transmits and receives a wireless signal via the antenna 840. The radio communication interface 863 can generally comprise, for example, an RF circuit 864. The RF circuit 864 can comprise, for example, a mixer, a filter, and an amplifier, and transmits and receives a wireless signal via the antenna 840. As shown in FIG. 8, the radio communication interface 863 can comprise a plurality of RF circuits 864. For example, the plurality of RF circuits 864 can support the plurality of antenna elements. Although FIG. 8 shows an example in which the radio communication interface 863 comprises the plurality of RF circuits 864, the radio communication interface 863 can comprise a single RF circuit 864.

In the gNB 800 and the gNB 830 shown in FIGS. 7 and 8, the one or more components included in the processing circuit 4010 described with reference to FIG. 4 can be implemented in a wireless communication interface 912. Alternatively, at least a part of these components can also be implemented by the controllers 821 and 851.

[Application Examples with Respect to Terminal Device]

### First Application Example

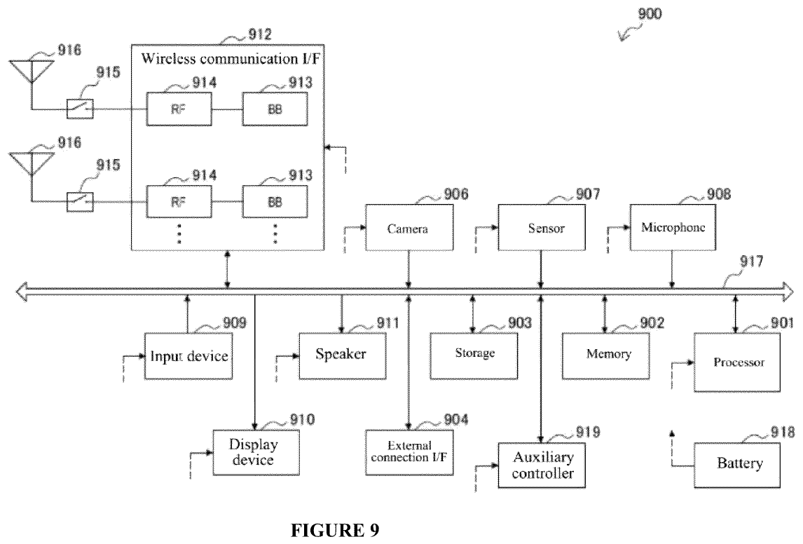

FIG. 9 is a block diagram illustrating an example of a schematic configuration of a smartphone 900 to which the technique of the present disclosure can be applied. The smartphone 900 comprises a processor 901, a memory 902, a storage device 903, an external connection interface 904, a camera 906, a sensor 907, a microphone 908, an input device 909, a display device 910, a speaker 911, a wireless communication interface 912, one or more antenna switches 915, one or more antennas 916, a bus 917, a battery 918, and an auxiliary controller 919.

The processor 901 can be, for example, a CPU or a system on chip (SoC), and controls functions of an application layer and other layers of the smartphone 900. The memory 902 comprises a RAM and a ROM, and stores data and a program executed by the processor 901. The storage device 903 can comprise a storage medium such as a semiconductor memory and a hard disk. The external connection interface 904 is an interface for connecting an external device such as a memory card and a universal serial bus (USB) device to the smartphone 900.

The camera 906 comprises an image sensor (such as a charge-coupled device (CCD) and a complementary metal oxide semiconductor (CMOS)), and generates a captured image. The sensor 907 can comprise a set of sensors such as a measurement sensor, a gyro sensor, a geomagnetic sensor, and an acceleration sensor. The microphone 908 converts sound inputted to the smartphone 900 into an audio signal. The input device 909 comprises, for example, a touch sensor configured to detect a touch on a screen of the display device 910, a keypad, a keyboard, a button, or a switch, and receives an operation or information inputted from a user. The display device 910 comprises a screen, such as a liquid crystal display (LCD) and an organic light-emitting diode (OLED) display, and displays an output image of the smartphone 900. The speaker 911 converts an audio signal output from the smartphone 900 into sound.

The wireless communication interface 912 supports any cellular communication solution (such as LTE and LTE-advanced), and performs wireless communication. The wireless communication interface 912 can generally comprise, for example, a BB processor 913 and an RF circuit 914. The BB processor 913 can perform, for example, encoding/decoding, modulation/demodulation, and multiplexing/demultiplexing, and perform various types of signal processing for the wireless communication. Meanwhile, the RF circuit 914 can comprise, for example, a mixer, a filter, and an amplifier, and transmits and receives a wireless signal via the antenna 916. The wireless communication interface 912 can be one chip module having the BB processor 913 and the RF circuit 914 integrated thereon. As shown in FIG. 9, the wireless communication interface 912 can comprise a plurality of BB processors 913 and a plurality of RF circuits 914. Although FIG. 9 shows an example in which the wireless communication interface 912 comprises the plurality of BB processors 913 and the plurality of RF circuits 914, the wireless communication interface 912 can also comprise a single BB processor 913 or a single RF circuit 914.

Furthermore, besides the cellular communication solution, the wireless communication interface 912 can support another type of wireless communication solution, such as a short-range wireless communication solution, a near field communication solution, and a wireless local area network (LAN) solution. In this case, the wireless communication interface 912 can comprise a BB processor 913 and an RF circuit 914 for each wireless communication solution.

Each of the antenna switches 915 switches a connection destination of the antenna 916 among a plurality of circuits (for example, circuits for different wireless communication solutions) included in the wireless communication interface 912.

Each of the antennas 916 comprises a single or a plurality of antenna elements (such as a plurality of antenna elements included in an MIMO antenna), and is used for the wireless communication interface 912 to transmit and receive a wireless signal. As shown in FIG. 9, the smartphone 900 can comprise a plurality of antennas 916. Although FIG. 9 shows an example in which the smartphone 900 comprises the plurality of antennas 916, the smartphone 900 can also comprise a single antenna 916.

Furthermore, the smartphone 900 can comprise an antenna 916 for each wireless communication solution. In this case, the antenna switch 915 can be omitted from the configuration of the smartphone 900.

The bus 917 connects the processor 901, the memory 902, the storage device 903, the external connection interface 904, the camera 906, the sensor 907, the microphone 908, the input device 909, the display device 910, the speaker 911, the wireless communication interface 912, and the auxiliary controller 919 to each other. The battery 918 supplies power to each block of the smartphone 900 shown in FIG. 9 via a feeder, which is partially shown as dashed lines in the figure. The auxiliary controller 919 operates minimum necessary functions of the smartphone 900, for example, in a sleep mode.

In the smartphone 900 shown in FIG. 9, the one or more components included in the processing circuit 2010 described with reference to FIG. 2 can be implemented in the wireless communication interface 912. Alternatively, at least a part of these components can also be implemented by the processor 901 or the auxiliary controller 919.

### Second Application Example

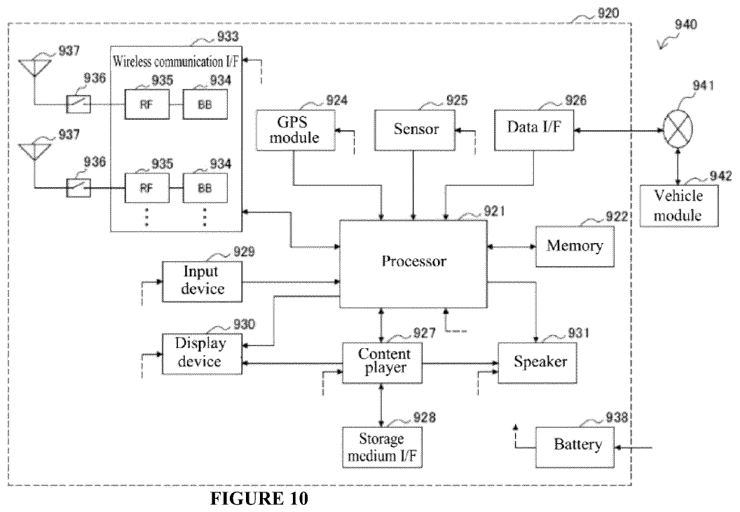

FIG. 10 is a block diagram illustrating an example of a schematic configuration of a car navigation device 920 to which the technique of the present disclosure can be applied. The car navigation device 920 comprises a processor 921, a memory 922, a global positioning system (GPS) module 924, a sensor 925, a data interface 926, a content player 927, a storage medium interface 928, an input device 929, a display device 930, a speaker 931, a wireless communication interface 933, one or more antenna switches 936, one or more antennas 937, and a battery 938.

The processor 921 can be, for example, a CPU or an SoC, and controls a navigation function and other functions of the car navigation device 920. The memory 922 comprises a RAM and a ROM, and stores data and a program executed by the processor 921. The GPS module 924 measures a location (such as latitude, longitude, and altitude) of the car navigation device 920 using a GPS signal received from a GPS satellite. The sensor 925 can comprise a set of sensors such as a gyro sensor, a geomagnetic sensor, and an air pressure sensor. The data interface 926 is connected to, for example, an in-vehicle network 941 via a terminal not shown, and acquires data generated by the vehicle (such as vehicle speed data).

The content player 927 reproduces content stored in a storage medium (such as a CD and a DVD), which is inserted into the storage medium interface 928. The input device 929 comprises, for example, a touch sensor configured to detect a touch on a screen of the display device 930, a button, or a switch, and receives an operation or information inputted from a user. The display device 930 comprises a screen such as an LCD or an OLED display, and displays an image for a navigation function or the reproduced content. The speaker 931 outputs sound for a navigation function or the reproduced content.

The wireless communication interface 933 supports any cellular communication solution (such as LTE and LTE-advanced), and performs wireless communication. The wireless communication interface 933 can generally comprise, for example, a BB processor 934 and an RF circuit 935. The BB processor 934 can perform, for example, encoding/decoding, modulation/demodulation, and multiplexing/demultiplexing, and perform various types of signal processing for the wireless communication. Meanwhile, the RF circuit 935 can comprise, for example, a mixer, a filter, and an amplifier, and transmit and receive a wireless signal via the antenna 937. The wireless communication interface 933 can also be one chip module having the BB processor 934 and the RF circuit 935 integrated thereon. As shown in FIG. 10, the wireless communication interface 933 can comprise a plurality of BB processors 934 and a plurality of RF circuits 935. Although FIG. 10 shows an example in which the wireless communication interface 933 comprises the plurality of BB processors 934 and the plurality of RF circuits 935, the wireless communication interface 933 can also comprise a single BB processor 934 or a single RF circuit 935.

Furthermore, besides the cellular communication solution, the wireless communication interface 933 can support other types of wireless communication solution, such as a short-range wireless communication solution, a near field communication solution, and a wireless LAN solution. In this case, the wireless communication interface 933 can comprise a BB processor 934 and an RF circuit 935 for each wireless communication solution.

Each of the antenna switches 936 switches a connection destination of the antenna 937 among the plurality of circuits (such as the circuits for the different wireless communication solutions) included in the wireless communication interface 933.

Each of the antennas 937 comprises a single or a plurality of antenna elements (such as a plurality of antenna elements included in an MIMO antenna), and is used for the wireless communication interface 933 to transmit and receive a wireless signal. As shown in FIG. 10, the car navigation device 920 can comprise a plurality of antennas 937. Although FIG. 10 shows an example in which the car navigation device 920 comprises the plurality of antennas 937, the car navigation device 920 can comprise a single antenna 937.

Furthermore, the car navigation device 920 can comprise an antenna 937 for each wireless communication solution. In this case, the antenna switch 936 can be omitted from the configuration of the car navigation device 920.

The battery 938 supplies power to each block of the car navigation device 920 shown in FIG. 10 via a feeder, which is partially shown as dashed lines in the figure. The battery 938 accumulates power supplied from the vehicle.

In the car navigation device 920 shown in FIG. 10, the one or more components included in the processing circuit 2010 described with reference to FIG. 2 can be implemented in the wireless communication interface 912. Alternatively, at least a part of these components can also be implemented by the processor 921.

The technique of the present disclosure can also be implemented as an in-vehicle system (or vehicle) 940 comprising the car navigation device 920, the in-vehicle network 941, and one or more blocks in a vehicle module 942. The vehicle module 942 generates vehicle data (such as vehicle speed, engine speed, and failure information), and outputs the generated data to the in-vehicle network 941.

It should be appreciated that the reference to “an embodiment” or similar expressions in this specification refers to that, a specific feature, structure, or characteristic described in combination with the embodiment is included in at least one specific embodiment of the present disclosure. Thus, in this specification, the appearance of the phrase “in an embodiment of the present disclosure” and similar expressions does not necessarily refer to the same embodiment.

Those skilled in the art should appreciate that the present disclosure is implemented as one system, apparatus, method, or computer-readable storage medium (for example, a non-transitory storage medium) as a computer program product. Accordingly, the present disclosure can be implemented in various forms, such as an entire hardware embodiment, an entire software embodiment (including firmware, resident software, micro-program code, etc.), or an embodiment combining software and hardware, which will be referred to hereinafter as a “circuit”, “module”, or “system”. Furthermore, the present disclosure can also, in a form of any tangible medium, be implemented as a computer program product, which has computer-usable program code stored thereon.

The related description of the present disclosure is described with reference to flow diagrams and/or block diagrams of the system, apparatus, method, and computer program product according to the specific embodiments of the present disclosure. It can be understood that each block in each flow diagram and/or block diagram, and any combination of blocks in the flow diagram and/or block diagram, can be implemented by using computer program instructions. These computer program instructions can be executed by a machine consisting of a processor of a general-purpose computer or a special computer, or other programmable data processing apparatuses, and the instructions are processed by the computer or other programmable data processing apparatuses, to implement the functions or operations described in the flow diagram and/or block diagram.

In the accompanying drawings, flow diagrams and block diagrams of the architecture, functions, and operations that can be implemented by the systems, apparatuses, methods and computer program products according to various embodiments of the present disclosure are illustrated. Accordingly, each block in the flow diagram or block diagram can represent one module, section, or portion of program code, which comprises one or more executable instructions to implement the specified logical function. In addition, it should be noted that, in some other embodiments, the functions described in the blocks may not be performed in the order shown in the figure. For example, two blocks shown in succession can also, in fact, be executed concurrently, or in some cases, in a reverse order of icons according to the functions involved. Furthermore, it will also be noted that each block of the block diagram and/or flow diagram, and a combination of blocks in the block diagram and/or flow diagram, can be implemented by a special-purpose hardware-based system, or a combination of special-purpose hardware and computer instructions, to perform the specific functions or operations.

The embodiments of the present disclosure have been described above, and the above description is exemplary, not exhaustive, and is not limited to the embodiments disclosed. Many modifications and variations will be apparent to those of ordinary skill in the art without departing from the scope and spirit of the described embodiments. The selection of the terms used herein is intend to best explain the principles, practical applications, or technical improvements to the market technology of the embodiments, or to enable others of ordinary skill in the art to understand the embodiments disclosed herein.

Note that the technique disclosed in this specification can have the following configurations.

(1) An electronic device used at a terminal device side, comprising:
a processing circuit configured to:
provide, via a cellular link, a direct link resource usage demand and a cellular link resource usage demand of the terminal device to a base station, so that the base station allocates direct link resources and cellular link resources for the terminal device according to the direct link resource usage demand and the cellular link resource usage demand of the terminal device.

(2) The electronic device according to (1), wherein
the direct link resource usage demand is indicated by at least one of channel busy ratio (CBR) or buffer status report (BSR) related to the direct link.

(3) The electronic device according to (1), wherein
the cellular link resource usage demand is indicated by buffer status report (BSR) related to the cellular link.

(4) The electronic device according to (1), wherein the processing circuit is further configured to:
acquire, via a direct link, a direct link resource usage demand and a cellular link resource usage demand of another terminal device, the another terminal device and the terminal device communicating with each other via the direct link to form a direct communication device group;
determine a direct link resource usage demand and a cellular link resource usage demand of the direct communication device group according to the direct link resource usage demands and the cellular link resource usage demands of the terminal devices in the direct communication device group; and
providing, via the cellular link, the direct link resource usage demand and the cellular link resource usage demand of the direct communication device group to the base station, so that the base station allocates a direct link resource pool for the direct communication device group according to the direct link resource usage demand and the cellular link resource usage demand of the direct communication device group.

(5) The electronic device according to (4), wherein the determining a direct link resource usage demand and a cellular link resource usage demand of the direct communication device group according to the direct link resource usage demands and the cellular link resource usage demands of the terminal devices in the direct communication device group comprises:
determining a maximum direct link resource usage demand among the terminal devices in the direct communication device group or an average direct link resource usage demand of the terminal devices as the direct link resource usage demand of the direct communication device group.

(6) The electronic device according to (4), wherein the determining a direct link resource usage demand and a cellular link resource usage demand of the direct communication device group according to the direct link resource usage demands and the cellular link resource usage demands of the terminal devices in the direct communication device group comprises:
determining a sum of the cellular link resource usage demands of the terminal devices in the direct communication device group as the cellular link resource usage demand of the direct communication device group.

(7) The electronic device according to (4), wherein the processing circuit is further configured to:
acquire location information of the terminal devices in the direct communication device group;
determine a maximum distance between the terminal devices in the direct communication device group according to the location information;
provide the maximum distance to the base station, so that the base station determines, according to the maximum distance, at least one of a spatial usage range of the direct link resource pool allocated for the direct communication device group or minimum direct communication transmission power of the direct communication device group.

(8) The electronic device according to (1), wherein the processing circuit is further configured to:
adjust an application layer media distribution mode of the terminal device according to the direct link resource usage demand and the cellular link resource usage demand.

(9) An electronic device used at a base station side, comprising:
a processing circuit configured to:
acquire, via a cellular link, a direct link resource usage demand and a cellular link resource usage demand of a terminal device; and
allocate direct link resources and cellular link resources for the terminal device according to the direct link resource usage demand and the cellular link resource usage demand.

(10) The electronic device according to (9), wherein
the direct link resource usage demand is indicated by at least one of channel busy ratio (CBR) or buffer status report (BSR) related to the direct link.

(11) The electronic device according to (9), wherein
the cellular link resource usage demand is indicated by buffer status report (BSR) related to the cellular link.

(12) The electronic device according to (9), wherein the allocating direct link resources and cellular link resources for the terminal device according to the direct link resource usage demand and the cellular link resource usage demand comprises:
adjusting a proportion of the direct link resources in uplink resources according to the direct link resource usage demand and the cellular link resource usage demand, and allocating the direct link resources and the cellular link resources to the terminal device according to the adjusted proportion.

(13) The electronic device according to (9), wherein the allocating direct link resources and cellular link resources for the terminal device according to the direct link resource usage demand and the cellular link resource usage demand comprises:
adjusting a ratio of the uplink resources to downlink resources according to the direct link resource usage demand and the cellular link resource usage demand, and allocating the direct link resources and the cellular link resources for the terminal device according to the adjusted ratio.

(14) The electronic device according to (9), wherein the processing circuit is further configured to:
acquire, via the cellular link, a direct link resource usage demand and a cellular link resource usage demand of a direct communication device group, the direct communication device group comprising a plurality of terminal devices that communicate with each other via the direct link;
allocate a direct link resource pool for the direct communication device group according to the direct link resource usage demand and the cellular link resource usage demand of the direct communication device group.

(15) The electronic device according to (14), wherein the processing circuit is further configured to:
allocate cellular downlink multicast resources for the direct communication device group according to the direct link resource usage demand and the cellular link resource usage demand of the direct communication device group.

(16) The electronic device according to (9), wherein the processing circuit is further configured to:
provide a media distribution control instruction for adjusting an application layer media distribution mode of the terminal device to the terminal device according to the direct link resource usage demand and the cellular link resource usage demand.

(17) The electronic device according to (9), wherein the processing circuit is further configured to:
adjust the allocation of the direct link resources and the cellular link resources according to interference with an adjacent base station.

(18) A communication method, comprising:
a terminal device providing, via a cellular link, a direct link resource usage demand and a cellular link resource usage demand of the terminal device to a base station, so that the base station allocates direct link resources and cellular link resources for the terminal device according to the direct link resource usage demand and the cellular link resource usage demand of the terminal device.

(19) A communication method, comprising:
a base station acquiring, through a cellular link, a direct link resource usage demand and a cellular link resource usage demand of a terminal device; and the base station allocating direct link resources and cellular link resources for the terminal device according to the direct link resource usage demand and the cellular link resource usage demand.

(20) A computer-readable storage medium, comprising executable instructions which, when executed by an information processing apparatus, cause the information processing apparatus to perform the communication method according to (18) or (19).

1. An electronic device used at a terminal device side, comprising:
a processing circuit configured to:
provide, via a cellular link, a direct link resource usage demand and a cellular link resource usage demand of the terminal device to a base station, so that the base station allocates direct link resources and cellular link resources for the terminal device according to the direct link resource usage demand and the cellular link resource usage demand of the terminal device.

2. The electronic device according to claim 1, wherein
the direct link resource usage demand is indicated by at least one of channel busy ratio (CBR) or buffer status report (BSR) related to the direct link.

3. The electronic device according to claim 1, wherein
the cellular link resource usage demand is indicated by buffer status report (BSR) related to the cellular link.

4. The electronic device according to claim 1, wherein the processing circuit is further configured to:
acquire, via a direct link, a direct link resource usage demand and a cellular link resource usage demand of another terminal device, the another terminal device and the terminal device communicating with each other via the direct link to form a direct communication device group;
determine a direct link resource usage demand and a cellular link resource usage demand of the direct communication device group according to the direct link resource usage demands and the cellular link resource usage demands of the terminal devices in the direct communication device group; and
providing, via the cellular link, the direct link resource usage demand and the cellular link resource usage demand of the direct communication device group to the base station, so that the base station allocates a direct link resource pool for the direct communication device group according to the direct link resource usage demand and the cellular link resource usage demand of the direct communication device group.

5. The electronic device according to claim 4, wherein the determining a direct link resource usage demand and a cellular link resource usage demand of the direct communication device group according to the direct link resource usage demands and the cellular link resource usage demands of the terminal devices in the direct communication device group comprises:
determining a maximum direct link resource usage demand among the terminal devices in the direct communication device group or an average direct link resource usage demand of the terminal devices as the direct link resource usage demand of the direct communication device group.

6. The electronic device according to claim 4, wherein the determining a direct link resource usage demand and a cellular link resource usage demand of the direct communication device group according to the direct link resource usage demands and the cellular link resource usage demands of the terminal devices in the direct communication device group comprises:
determining a sum of the cellular link resource usage demands of the terminal devices in the direct communication device group as the cellular link resource usage demand of the direct communication device group.

7. The electronic device according to claim 4, wherein the processing circuit is further configured to:
acquire location information of the terminal devices in the direct communication device group;
determine a maximum distance between the terminal devices in the direct communication device group according to the location information;
provide the maximum distance to the base station, so that the base station determines, according to the maximum distance, at least one of a spatial usage range of the direct link resource pool allocated for the direct communication device group or minimum direct communication transmission power of the direct communication device group.

8. The electronic device according to claim 1, wherein the processing circuit is further configured to:
adjust an application layer media distribution mode of the terminal device according to the direct link resource usage demand and the cellular link resource usage demand.

9. An electronic device used at a base station side, comprising:
a processing circuit configured to:
acquire, via a cellular link, a direct link resource usage demand and a cellular link resource usage demand of a terminal device; and
allocate direct link resources and cellular link resources for the terminal device according to the direct link resource usage demand and the cellular link resource usage demand.

10. The electronic device according to claim 9, wherein
the direct link resource usage demand is indicated by at least one of channel busy ratio (CBR) or buffer status report (BSR) related to the direct link.

11. The electronic device according to claim 9, wherein
the cellular link resource usage demand is indicated by buffer status report (BSR) related to the cellular link.

12. The electronic device according to claim 9, wherein the allocating direct link resources and cellular link resources for the terminal device according to the direct link resource usage demand and the cellular link resource usage demand comprises:
adjusting a proportion of the direct link resources in uplink resources according to the direct link resource usage demand and the cellular link resource usage demand, and allocating the direct link resources and the cellular link resources to the terminal device according to the adjusted proportion.

13. The electronic device according to claim 9, wherein the allocating direct link resources and cellular link resources for the terminal device according to the direct link resource usage demand and the cellular link resource usage demand comprises:
adjusting a ratio of the uplink resources to downlink resources according to the direct link resource usage demand and the cellular link resource usage demand, and allocating the direct link resources and the cellular link resources for the terminal device according to the adjusted ratio.

14. The electronic device according to claim 9, wherein the processing circuit is further configured to:
acquire, via the cellular link, a direct link resource usage demand and a cellular link resource usage demand of a direct communication device group, the direct communication device group comprising a plurality of terminal devices that communicate with each other via the direct link;
allocate a direct link resource pool for the direct communication device group according to the direct link resource usage demand and the cellular link resource usage demand of the direct communication device group.

15. The electronic device according to claim 14, wherein the processing circuit is further configured to:
allocate cellular downlink multicast resources for the direct communication device group according to the direct link resource usage demand and the cellular link resource usage demand of the direct communication device group.

16. The electronic device according to claim 9, wherein the processing circuit is further configured to perform at least one of:
providing a media distribution control instruction for adjusting an application layer media distribution mode of the terminal device to the terminal device according to the direct link resource usage demand and the cellular link resource usage demand; or
adjusting the allocation of the direct link resources and the cellular link resources according to interference with an adjacent base station.

17. (canceled)

18. A communication method, comprising:
a terminal device providing, via a cellular link, a direct link resource usage demand and a cellular link resource usage demand of the terminal device to a base station, so that the base station allocates direct link resources and cellular link resources for the terminal device according to the direct link resource usage demand and the cellular link resource usage demand of the terminal device.

19. A communication method, comprising:
a base station acquiring, through a cellular link, a direct link resource usage demand and a cellular link resource usage demand of a terminal device; and
the base station allocating direct link resources and cellular link resources for the terminal device according to the direct link resource usage demand and the cellular link resource usage demand.

20. A computer-readable storage medium, comprising executable instructions which, when executed by an information processing apparatus, cause the information processing apparatus to perform a communication method comprising:
a terminal device providing, via a cellular link, a direct link resource usage demand and a cellular link resource usage demand of the terminal device to a base station, so that the base station allocates direct link resources and cellular link resources for the terminal device according to the direct link resource usage demand and the cellular link resource usage demand of the terminal device.

21. A computer-readable storage medium, comprising executable instructions which, when executed by an information processing apparatus, cause the information processing apparatus to perform a communication method comprising:
a base station acquiring, through a cellular link, a direct link resource usage demand and a cellular link resource usage demand of a terminal device; and
the base station allocating direct link resources and cellular link resources for the terminal device according to the direct link resource usage demand and the cellular link resource usage demand.
